(19) United States
(12) Patent Application Publication
(10) Pub. No.: US 2012/0302213 A1
(43) Pub. Date: Nov. 29, 2012

(54) METHOD, DEVICE, AND SYSTEM FOR SELECTING FEMTOCELL GATEWAY

(76) Inventors: Guiming SHU, Shenzhen (CN); Zhiming Ding, Shenzhen (CN)

(21) Appl. No.: 13/570,592

(22) Filed: Aug. 9, 2012

Related U.S. Application Data
(63) Continuation-in-part of application No. PCT/CN2011/070453, filed on Jan. 21, 2011.

(30) Foreign Application Priority Data
Feb. 10, 2010 (CN) 201010111296.6

(51) Int. Cl. H04W 48/20; H04W 88/16; H04W 12/06; H04W 60/00; H04W 12/00

(52) U.S. Cl. 455/411; 455/435.1; 455/410; 455/561

(57) ABSTRACT

A method for selecting a Femtocell gateway includes: selecting, according to service capability information of a Femtocell gateway in the current network, a target Femtocell gateway; and sending a message that carries identification information of the target Femtocell gateway to the Femtocell for the Femtocell to access, according to the identification information of the target Femtocell gateway, the target Femtocell gateway corresponding to the identification information of the target Femtocell gateway, or for the target Femtocell gateway to perform a pre-attachment operation for a terminal requesting for access to the network.

### CROSS-REFERENCE TO RELATED APPLICATIONS

This application is a continuation in part of International Application No. PCT/CN2011/070453, filed on Jan. 21, 2011, which claims priority to Chinese Patent Application No. 201010111296.6, filed with the Chinese Patent Office on Feb. 10, 2010 and entitled “METHOD, DEVICE, AND SYSTEM FOR SELECTING FEMTOCELL GATEWAY”, both of which are incorporated herein by reference in their entireties.

### FIELD OF THE INVENTION

The present invention relates to the field of radio access technologies, and in particular, to a method, a device, and a system for selecting a Femtocell gateway.

### BACKGROUND OF THE INVENTION

In order to improve the network coverage of a worldwide interoperability for microwave access (Worldwide interoperability for Microwave Access, WiMAX) network, especially the indoor coverage, a WiMAX Femtocell is deployed indoors, and the WiMAX Femtocell is connected through a broadband network to a core network or a WiMAX macro cell network provided by a WiMAX Femtocell network service provider, where a new WiMAX Femtocell network service provider who is responsible for operation, authentication, and management of the WiMAX Femtocell is introduced in the WiMAX network.

The WiMAX Femtocell is connected to a Femtocell gateway through a security gateway, and further accesses the core network or the WiMAX macro cell network provided by the WiMAX Femtocell network service provider. The Femtocell gateway that is connected with the WiMAX Femtocell is selected at the time of power-on initialization of the WiMAX Femtocell, and after the WiMAX Femtocell works normally, the WiMAX Femtocell maintains access to the core network or the WiMAX macro cell network provided by the WiMAX Femtocell network service provider through the Femtocell gateway that is selected at the time of power-on initialization. If the Femtocell gateway that is selected at the time of power-on initialization cannot provide normal services for the WiMAX Femtocell or a terminal, for example, due to the overload of the Femtocell gateway or malfunction of the Femtocell gateway, the quality of communication services of the terminal connected with the Femtocell is affected.

### SUMMARY OF THE INVENTION

Embodiments of the present invention provide a method, a device, and a system for selecting a Femtocell gateway, so as to solve the problem that the quality of communication services of the terminal is affected because the Femtocell gateway cannot provide normal services.

A method for selecting a Femtocell gateway includes: selecting, according to service capability information of a Femtocell gateway in a current network, a target Femtocell gateway; and sending a message that carries identification information of the target Femtocell gateway to the Femtocell, so that the Femtocell accesses, according to the identification information of the target Femtocell gateway, the target Femtocell gateway corresponding to the identification information of the target Femtocell gateway, or so that the Femtocell performs, through the target Femtocell gateway, a pre-attachment operation for a terminal requesting for access to the network.

A method for selecting a Femtocell gateway includes: receiving a message that carries identification information of a target Femtocell gateway; and establishing, according to the identification information of the target Femtocell gateway in the message, a communication connection with the target Femtocell gateway, and/or performing, according to the identification information of the target Femtocell gateway in the message, a pre-attachment operation for a terminal requesting for access to a network.

A network management entity includes:

a selecting unit, configured to select a target Femtocell gateway according to service capability information of a Femtocell gateway in a current network; and

a first sending unit, configured to send a message that carries identification information of the target Femtocell gateway selected by the selecting unit to the Femtocell.

A Femtocell includes:

a first receiving unit, configured to receive a message that carries identification information of a target Femtocell gateway;

a first executing unit, configured to establish, according to the identification information of the target Femtocell gateway in the message received by the first receiving unit, a communication connection with the target Femtocell gateway; and/or

a second executing unit, configured to perform, through the target Femtocell gateway according to the identification information of the target Femtocell gateway in the message received by the first receiving unit, a pre-attachment operation for a terminal requesting for access to a network.

A system for selecting a Femtocell gateway includes:

a network management entity, configured to select a target Femtocell gateway according to service capability information of a Femtocell gateway in a current network, and send a message that carries identification information of the target Femtocell gateway to the Femtocell; and

the Femtocell, configured to receive the message that carries the identification information of the target Femtocell gateway, and establish, according to the identification information of the target Femtocell gateway in the message, a communication connection with the target Femtocell gateway, and/or perform, through the target Femtocell gateway according to the identification information of the target Femtocell gateway in the message, a pre-attachment operation for a terminal requesting for access to the network.

With the method, device, and system for selecting a Femtocell gateway provided by the embodiments of the present invention, the network management entity sends a message that carries the identification information of the target Femtocell gateway to the Femtocell connected with an original Femtocell gateway, so that the Femtocell selects the target Femtocell gateway that can provide normal services, and therefore the problem that the quality of communication services of user equipments is affected because the Femtocell gateway cannot provide normal services is solved.

### BRIEF DESCRIPTION OF THE DRAWINGS

FIG. 1 is a flow chart of a method for selecting a Femtocell gateway according to an embodiment of the present invention;

FIG. 2 is a flow chart of a method for selecting a Femtocell gateway according to an embodiment of the present invention;

FIG. 3 is a flow chart of step 202 in the flow chart of the method for selecting a Femtocell gateway as shown in FIG. 2;

FIG. 4 is a first sequence chart of a method for selecting a Femtocell gateway according to still another embodiment of the present invention;

FIG. 5 is a second sequence chart of a method for selecting a Femtocell gateway according to still another embodiment of the present invention;

FIG. 6 is a third sequence chart of a method for selecting a Femtocell gateway according to still another embodiment of the present invention;

FIG. 7 is a sequence chart of a method for selecting a Femtocell gateway according to yet another embodiment of the present invention;

FIG. 8 is a first sequence chart of a method for selecting a Femtocell gateway according to another embodiment of the present invention;

FIG. 9 is a second sequence chart of a method for selecting a Femtocell gateway according to another embodiment of the present invention;

FIG. 10 is a third sequence chart of a method for selecting a Femtocell gateway according to another embodiment of the present invention;

FIG. 11 is a sequence chart of a method for selecting a Femtocell gateway according to still another embodiment of the present invention;

FIG. 12 is a first schematic structural diagram of a network device according to an embodiment of the present invention;

FIG. 13 is a first schematic structural diagram of a selecting unit in the network device as shown in FIG. 12;

FIG. 14 is a second schematic structural diagram of a selecting unit in the network device as shown in FIG. 13;

FIG. 15 is a second schematic structural diagram of a network device according to an embodiment of the present invention;

FIG. 16 is a schematic structural diagram of a network device according to still another embodiment of the present invention;

FIG. 17 is a schematic structural diagram of a first executing unit in a Femtocell as shown in FIG. 16;

FIG. 18 is a schematic structural diagram of a Femtocell according to another embodiment of the present invention;

FIG. 19 is a schematic structural diagram of a Femtocell according to yet another embodiment of the present invention;

FIG. 20 is a schematic structural diagram of a Femtocell according to still another embodiment of the present invention; and

FIG. 21 is a schematic structural diagram of a system for selecting a Femtocell gateway according to an embodiment of the present invention.

### DETAILED DESCRIPTION OF THE EMBODIMENTS

In order to solve the problem in the prior art that the quality of communication services of a mobile terminal is affected because a Femtocell gateway cannot provide normal services, embodiments of the present invention provide a method, a device, and a system for selecting a Femtocell gateway.

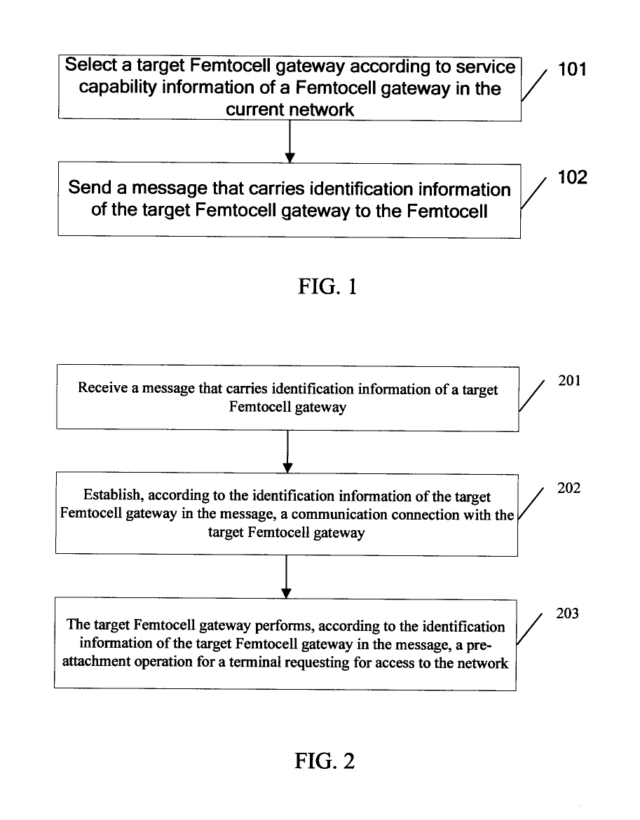

As shown FIG. 1, a method for selecting a Femtocell gateway provided by an embodiment of the present invention includes the following:

Step 101: Select a target Femtocell gateway according to service capability information of a Femtocell gateway in the current network.

In step 101, the service capability information of the Femtocell gateway in the current network is load capability information of the Femtocell gateway in the current network.

In this embodiment, the failure of the original Femtocell gateway accessed by the Femtocell to provide normal services for the Femtocell includes an occurrence of an overload of the original Femtocell gateway, or a need for transmission optimization of the whole network, or an occurrence of a malfunction of the original Femtocell gateway. When the original Femtocell gateway accessed by the Femtocell cannot provide normal services for the Femtocell, a network management entity may select a target Femtocell gateway that can replace the original Femtocell gateway.

Step 102: Send a message that carries identification information of the target Femtocell gateway to the Femtocell.

In this embodiment, the Femtocell is enabled to access, according to the message that carries the identification information of the target Femtocell gateway, the target Femtocell gateway corresponding to the identification information of the target Femtocell gateway, thus implementing selection of a Femtocell gateway, or enabling the target Femtocell gateway to perform a pre-attachment operation for a terminal requesting for access to the network.

With the method for selecting a Femtocell gateway provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

As shown in FIG. 2, a method for selecting a Femtocell gateway provided by an embodiment of the present invention includes the following steps:

Step 201: Receive a message that carries identify information of a target Femtocell gateway.

In this embodiment, the message that carries the identification information of the target Femtocell gateway is sent by a network management entity, such as a self-organized network (Self-Organized Network, SON) server.

The SON server is a logical network management functional entity, which may be deployed separately or deployed on a Femtocell gateway. When the SON server is deployed on the Femtocell gateway, the message that carries the identification information of the target Femtocell gateway is just sent from the Femtocell gateway to the Femtocell.

Step 202: Establish, according to the identification information of the target Femtocell gateway in the message, a communication connection with the target Femtocell gateway.

Step 203: The target Femtocell gateway performs, according to the identification information of the target Femtocell gateway in the message, a pre-attachment operation for a terminal requesting for access to the network.

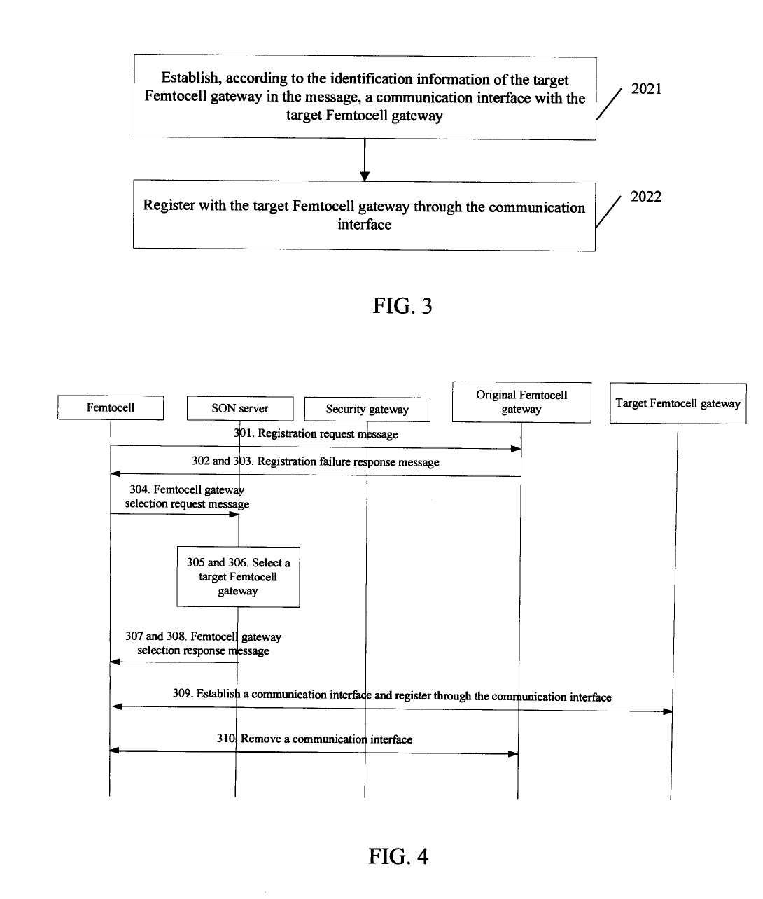

In this embodiment, step 202, as shown in FIG. 3, includes: Step 2021: Establish, according to the identification information of the target Femtocell gateway in the message, a communication interface with the target Femtocell gateway. Step 2022: Register with the target Femtocell gateway through the communication interface.

With the method for selecting a Femtocell gateway provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

The method for selecting a Femtocell gateway provided by the embodiment of the present invention is illustrated in detail below through exemplary embodiments.

As shown in FIG. 4, the method for selecting a Femtocell gateway provided by still another embodiment of the present invention is applied when it is required to select a Femtocell gateway after an initialization process of a Femtocell is completed and registration to a Femtocell gateway fails. The implementation of this method is conditional upon a request by the Femtocell for registration to the original Femtocell gateway.

In the embodiment of the present invention, when the Femtocell requests for registering with the original Femtocell gateway, the original Femtocell gateway returns a registration failure response message to the Femtocell, where the registration failure response message includes information about a reason for the registration failure; and when the Femtocell receives the registration failure response message, the Femtocell sends a Femtocell gateway selection request message to the SON server, and carries information about a reason for the selection in the message, where the reason information may be the information about the reason for the registration failure that is received by the Femtocell, so that the SON server selects a new Femtocell gateway for the Femtocell, that is, the target Femtocell gateway. The specific steps of this embodiment are as follows:

Step 301: The Femtocell sends a registration request message to the original Femtocell gateway. This step occurs after the initialization process of the Femtocell is completed, or when the registration is initiated again after deregistration during the operation of the Femtocell.

Step 302: The original Femtocell gateway returns a registration failure response message to the Femtocell.

In this embodiment, when the load of access to the Femtocell gateway has been in a saturated state, or according to an operation policy, the Femtocell gateway no longer accepts access by the Femtocell, the Femtocell sends the registration request message to the original Femtocell gateway, the original Femtocell gateway returns a registration failure response message to the Femtocell, where the registration failure response message includes the information about the reason for registration failure.

Step 303: The Femtocell receives the registration failure response message, where the message includes the reason for registration failure, such as overload and transmission optimization.

Step 304: When the Femtocell receives the registration failure response message, the Femtocell sends a Femtocell gateway selection request message (such as a FeGW Re-selection Request) to the SON server, where the message includes information about the reason for selecting a Femtocell gateway and/or identification information of the original Femtocell gateway. The information about the reason for selecting a Femtocell gateway may be information about the reason for registration failure, information about the reason for deregistration, and so on, which is used as a reference basis when the SON server selects the Femtocell gateway. The identification information of the original Femtocell gateway here may be an IP (Internet protocol, Internet Protocol) address or a MAC (Media Access Control, media access control) address of the original Femtocell gateway, or other information that may identify the identity or the communication address of a Femtocell gateway in the network. The identification information of the original Femtocell gateway enables the SON server to avoid selecting the original Femtocell gateway again. In addition, the SON server may also record the Femtocell gateway used by each Femtocell at the time of initialization of the Femtocell. The SON server is a logical network management functional entity, which may be deployed separately or deployed on a Femtocell gateway. When the SON server is deployed on the Femtocell gateway, the Femtocell gateway selection request message sent by the Femtocell to the SON server is just sent from the Femtocell to the Femtocell gateway of the Femtocell.

Step 305: When the SON server receives the Femtocell gateway selection request message that is sent by the Femtocell, judges that the original Femtocell gateway cannot provide normal services for the Femtocell, and acquires, according to the information that is about the reason for selecting a gateway access and is included in the message, the reason for the Femtocell to select, or acquires, according to the identification information of the original Femtocell gateway access, the Femtocell gateway originally used by the Femtocell.

Step 306: When the original Femtocell gateway cannot provide normal services for the Femtocell, the SON server selects a target Femtocell gateway that can replace the original Femtocell gateway.

In this embodiment, the SON server selects the target Femtocell gateway that can replace the original Femtocell gateway through the following steps: When the original Femtocell gateway is overloaded, the SON server firstly obtains the load information of the Femtocell connected with the Femtocell gateway in the network where the SON server is located, and calculates, according to the load information of the Femtocell connected with the Femtocell gateway in the network, a load condition of the Femtocell gateway in the network, and then selects the target Femtocell gateway according to the load condition. During the selection of the target Femtocell gateway, with reference to the location information of the Femtocell that needs to select a Femtocell gateway and the information that is about the reason for selecting Femtocell gateway and is included in the Femtocell gateway selection request message sent by the Femtocell, a target Femtocell gateway that meets the need of the Femtocell is selected for the Femtocell, and the identification information of the target Femtocell gateway is obtained. It is worth noting that the location information of the Femtocell is physical location information of the Femtocell.

In this embodiment, the selecting, by the SON server, the target Femtocell gateway that can replace the original Femtocell gateway includes: obtaining the load information of the Femtocell connected with the Femtocell gateway in the current network; calculating, according to the load information of the Femtocell connected with the Femtocell gateway in the current network, the load condition of the Femtocell gateway in the current network; and selecting the target Femtocell gateway according to the load condition.

Step 307: The SON server sends a message that carries the identification information of the target Femtocell gateway to the Femtocell, that is, sends a Femtocell gateway selection response message (such as an FeGW Re-selection Response). The identification information of the target Femtocell gateway here may be an IP (Internet protocol) address or a MAC (Media Access Control, media access control) address of the target Femtocell gateway, or other information that may identify the identity or the communication address of a Femtocell gateway in the network.

Step 308: The Femtocell receives the message that carries the identification information of the target Femtocell gateway, that is, receives the Femtocell gateway selection response message.

Step 309: The Femtocell establishes, according to the identification information of the target Femtocell gateway in the message, a communication interface with the target Femtocell gateway, and registers to the target Femtocell gateway through the communication interface. For the WiMAX Femtocell network, the mentioned communication interface is an R6-F interface.

Step 310: The Femtocell removes a communication interface with the original Femtocell gateway.

The embodiment of the present invention enables the Femtocell to connect to the target Femtocell gateway through the security gateway, and provides the mobile terminal with the service of access to the WiMAX service network through the target Femtocell gateway.

For the method according to the embodiment of the present invention, the sequence of the steps may be adjusted or the steps may be combined according to actual needs. For example, step 310 may be performed after step 303, that is, immediately after the Femtocell receives the registration failure response message sent by the original Femtocell gateway, the Femtocell and the original Femtocell gateway may remove the communication interface between them. Step 310 may not necessarily be initiated immediately after the Femtocell receives the registration failure response message, and a timer may be set in the Femtocell and when the timer expires, the communication interface with the original Femtocell gateway is automatically removed. If at the time of initialization, the Femtocell establishes communication interfaces with multiple Femtocell gateways, step 309 may not necessarily be performed; that is, if at the time of initialization, the Femtocell has established a communication interface and registered with the target Femtocell gateway, step 309 may not be performed.

With the method for selecting a Femtocell gateway provided by the embodiment of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway may be selected when the Femtocell fails to register with the original Femtocell gateway after the Femtocell works normally upon power-on initialization, thus solving the problem that the quality of communication services of user equipments is affected because the Femtocell gateway cannot provide normal services.

Further, the target Femtocell gateway and the original Femtocell gateway may not necessarily be connected with the Femtocell through the same security gateway.

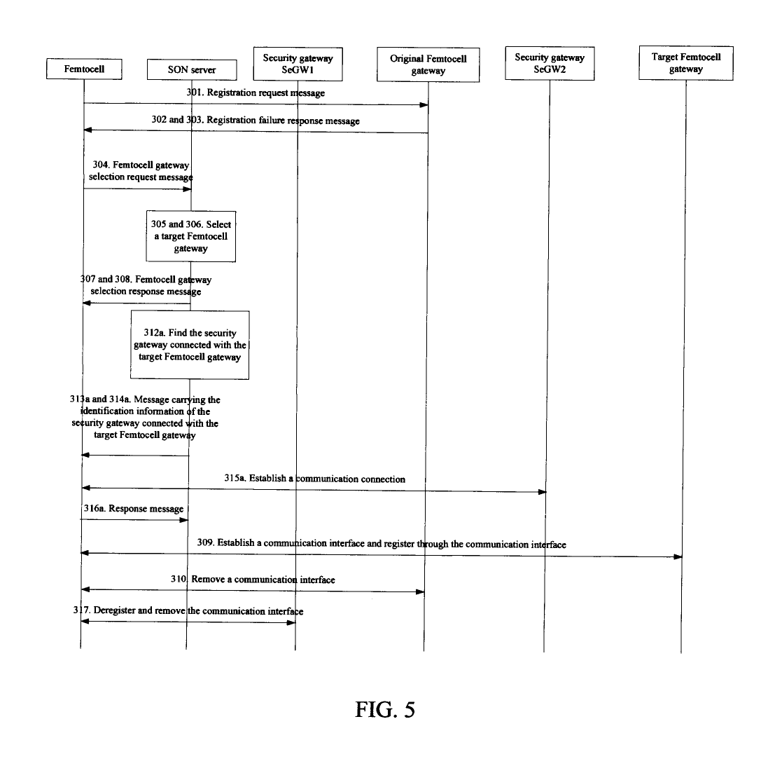

In a method for selecting a Femtocell gateway provided by still another embodiment of the present invention, as shown in FIG. 5, the SON server judges whether the security gateway (SeGW2) connected with the target Femtocell gateway and the security gateway (SeGW1) connected with the original Femtocell gateway are the same security gateway, avoiding the occurrence of a circumstance under which the target Femtocell gateway and the original Femtocell gateway are not connected with the Femtocell through the same security gateway so that the target Femtocell gateway cannot communicate with the Femtocell. Specific steps of this method may include the above step 301 to step 310, and after step 308, the method also includes the following:

Step 312a: When the security gateway connected with the target Femtocell gateway and the security gateway connected with the original Femtocell are not the same security gateway, the SON server finds the security gateway connected with the target Femtocell gateway.

In this embodiment, the SON server judges whether the target Femtocell gateway and the original Femtocell gateway are connected with the same security gateway. This judgment may be performed through a pre-stored table of a connection relationship between a security gateway and a Femtocell gateway. The relationship table may be pre-stored in a SON server or a bootstrap server. Moreover, after finding the security gateway connected with the target Femtocell gateway, the SON server may obtain, through the bootstrap server, the IP address of the security gateway connected with the target Femtocell gateway, and use the IP address as the identification information of the security gateway.

The identification information of the security gateway may not be limited to being represented by the IP address, and the way of obtaining the IP address is not limited to obtaining through the bootstrap server. The identification information of the security gateway here may be an IP (Internet protocol) address or a MAC (Media Access Control, media access control) address of the security gateway, or other information that may identify the identity or the communication address of the security gateway in the network.

Step 313a: The SON server sends a message that carries the identification information of the security gateway connected with the target Femtocell gateway to the Femtocell. The identification information of the security gateway here may be an IP (Internet protocol) address or a MAC (Media Access Control, media access control) address of the security gateway, or other information that may identify the identity or the communication address of the security gateway in the network.

Step 314a: The Femtocell receives the message that carries the identification information of the security gateway connected with the target Femtocell gateway.

Step 315a: The Femtocell establishes a communication connection with the security gateway according to the message that carries the identification information of the security gateway connected with the target Femtocell gateway. The communication connection here generally refers to a security tunnel (IP Sec tunnel) between the Femtocell and the security gateway. During the specific implementation of this step, after the IP Sec tunnel is established between the Femtocell and the security gateway, according to a specific authentication policy, this procedure may trigger an authentication procedure for the Femtocell in a Femtocell authentication server through the security gateway connected with the target Femtocell gateway. For a specific authentication procedure, reference may be made to the existing specifications.

Step 316a: The Femtocell returns a response message to the SON server to confirm that the identification information of the security gateway is received, and indicates a result of establishment of communication between the Femtocell and the security gateway. The present invention does not limit the moment at which the message is sent, but if the message is sent before step 315a, the message is unable to indicate the result of establishment of communication between the Femtocell and the security gateway.

After step 316a, steps 309, 310 and 317 are performed.

Step 317: The Femtocell removes the communication connection with the security gateway. The security gateway is the security gateway that is connected with the original Femtocell gateway. The communication connection here generally refers to a security tunnel (IP Sec tunnel) between the Femtocell and the security gateway. During the specific implementation of this step, the Femtocell and the security gateway remove the IP Sec tunnel between the Femtocell and the security gateway, and according to a specific authentication policy, this procedure may trigger a de-authentication procedure for the Femtocell in a Femtocell authentication server through the security gateway connected with the original Femtocell gateway. For a specific authentication procedure, reference may be made to the existing specifications.

In this embodiment, the establishment of the communication connection with the security gateway is implemented through the following steps: The Femtocell establishes an IP Sec tunnel with the security gateway connected with the target Femtocell gateway, and completes an authentication procedure through an authenticator in the security gateway and a Femtocell authentication server.

For the method according to the embodiment of the present invention, the sequence of the steps may be adjusted or the steps may be combined according to actual needs. Step 312a may be combined with step 305 and step 306, that is, selecting the target Femtocell gateway at the same time when finding the security gateway connected with the target Femtocell gateway. In this case, the identification information of the security gateway connected with the target Femtocell gateway may be carried in the Femtocell gateway selection response message of step 307 and step 308 and sent to the Femtocell, and steps 313a and 314a may not be performed. If at the time of initialization, the Femtocell has established a communication connection with the security gateway connected with the target Femtocell gateway, and has established a communication interface and registered with the target Femtocell gateway, steps 315a and 309 may not be performed. Step 310 may be performed after step 303, that is, immediately after the Femtocell receives the registration failure response message sent by the original Femtocell gateway, the Femtocell and the original Femtocell gateway may remove the communication interface between them. Step 310 may not necessarily be initiated immediately after the Femtocell receives the registration failure response message, and a timer may be set in the Femtocell and when the timer expires, the communication interface with the original Femtocell gateway is automatically removed.

With the method for selecting a Femtocell gateway provided by the embodiment of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway may be selected when the Femtocell fails to register with the original Femtocell gateway after the Femtocell works normally upon power-on initialization, thus solving the problem that the quality of communication services of user equipments is affected because the Femtocell gateway cannot provide normal services.

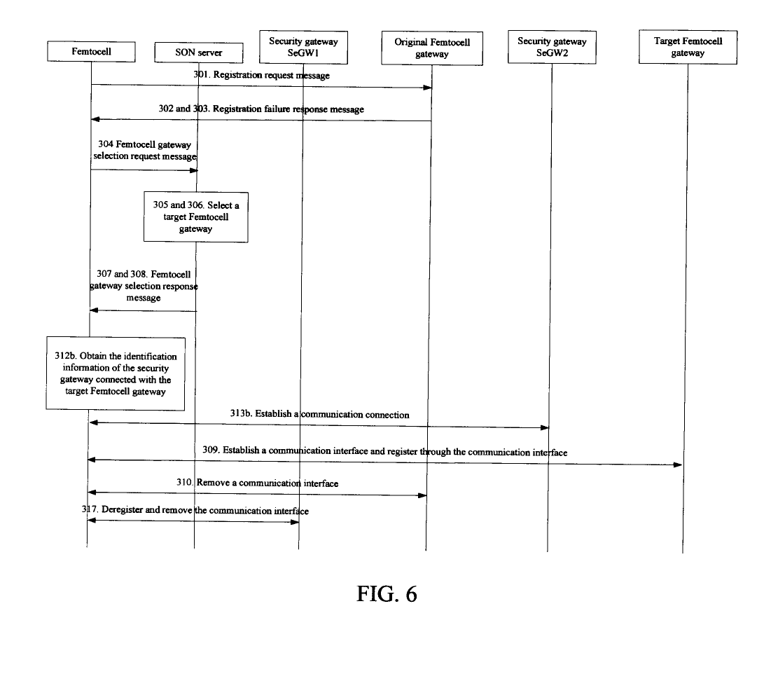

In a method for selecting a Femtocell gateway provided by still another embodiment of the present invention, as shown in FIG. 6, the Femtocell judges whether the security gateway (SeGW2) connected with the target Femtocell gateway and the security gateway (SeGW1) connected with the original Femtocell gateway are the same security gateway, avoiding the occurrence of a circumstance under which the target Femtocell gateway and the original Femtocell gateway are not connected with the Femtocell through the same security gateway so that the target Femtocell gateway cannot communicate with the Femtocell. The specific steps of the method include the above step 301 to step 310, and after step 308, the method also includes the following:

Step 312b: When the security gateway connected with the target Femtocell gateway and the security gateway connected with the original Femtocell gateway are not the same security gateway, obtain the identification information of the security gateway connected with the target Femtocell gateway.

In this embodiment, the Femtocell judges whether the target Femtocell gateway and the original Femtocell gateway are connected with the same security gateway. This judgment may be performed through a pre-stored table of a connection relationship between a security gateway and a Femtocell gateway. The relationship table may be pre-stored in a SON server or a bootstrap server. Moreover, the Femtocell may obtain, through the bootstrap server, the IP address of the security gateway connected with the target Femtocell gateway, as the identification information of the security gateway.

The identification information of the security gateway may not be limited to being represented by the IP address and the MAC address, and the way of obtaining the IP address is not limited to obtaining through the bootstrap server.

Step 313b: Establish a communication connection with the security gateway according to the identification information of the security gateway. In this embodiment, the methods for implementing step 313b and step 315a are the same, and are not repeated here.

After step 313b, steps 309, 310, and 317 are performed.

Step 317: The Femtocell removes the communication interface with the security gateway. The security gateway is the security gateway that is connected with the original Femtocell gateway.

For the method according to the embodiment of the present invention, the sequence of the steps may be adjusted or the steps may be combined according to actual needs. If at the time of initialization, the Femtocell has established a communication connection with the security gateway connected with the target Femtocell, and has established a communication interface and registered with the target Femtocell, steps 313b and 309 may not be performed. Step 310 may be performed after step 303, that is, immediately after the Femtocell receives the registration failure response message sent by the original Femtocell gateway, the Femtocell and the original Femtocell gateway may remove the communication interface between them. Definitely, step 310 may not necessarily be initiated immediately after the Femtocell receives the registration failure response message, and a timer may be set in the Femtocell and when the timer expires, the communication interface with the original Femtocell gateway is automatically removed.

With the method for selecting a Femtocell gateway provided by the embodiments of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway may be selected when the Femtocell fails to register with the original Femtocell gateway after the Femtocell works normally upon power-on initialization, thus solving the problem that the quality of communication services of user equipments is affected because the Femtocell gateway cannot provide normal services.

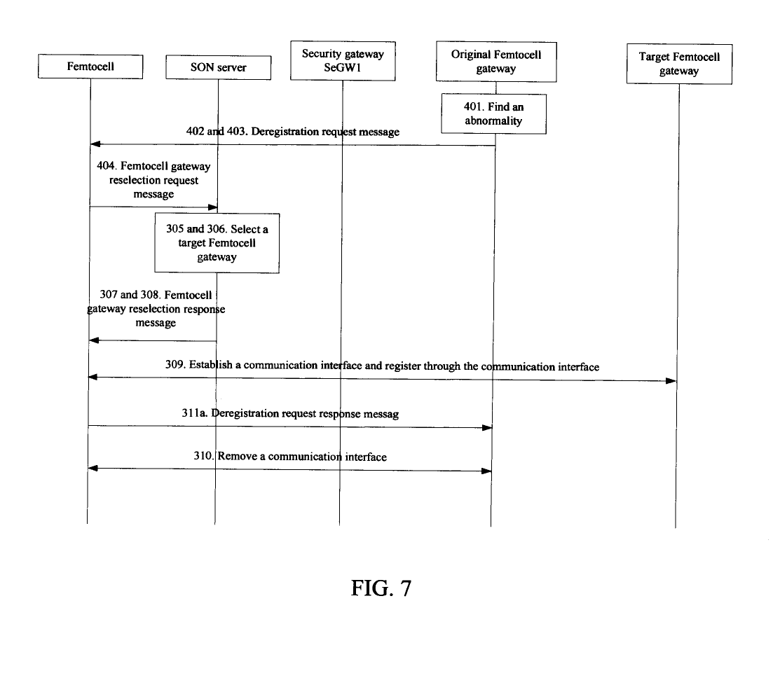

As shown in FIG. 7, yet another embodiment of the present invention is applied during the operation of the network. The implementation of this method is subject to the condition that the Femtocell connects to the Femtocell gateway through the security gateway, and through the Femtocell gateway, provides the mobile terminal with the service of access to the WiMAX service network

In the embodiment of the present invention, the original Femtocell gateway, because of actively finding an overload in itself, or for such reasons as transmission optimization or upcoming shutdown, selects one or more Femtocells from the Femtocells connected with the original Femtocell gateway and sends a deregistration request message to the selected Femtocell, where the message carries the information about the reason for deregistration. The Femtocell receives the deregistration request message, sends a Femtocell gateway selection request message to the SON server, and carries the information about the reason for selection in the message, where the reason information may be the information about the reason for deregistration that is carried in the deregistration request message received by the Femtocell, so that the SON server reallocates a new Femtocell gateway to the Femtocell, that is, the target Femtocell gateway. The specific steps of this method are as follows:

Step 401: The original Femtocell gateway finds an abnormality of its own.

In this embodiment, the abnormality of its own includes the overload of the original Femtocell gateway, transmission optimization needed by the original Femtocell gateway, or upcoming shutdown of the original Femtocell, and so on.

Step 402: When the original Femtocell gateway finds an abnormality of its own, the original Femtocell gateway sends a deregistration request message to the Femtocell.

In this embodiment, the deregistration request message includes overload information or information about a reason such as transmission optimization or upcoming shutdown; and the Femtocell is one or more of multiple Femtocells connected with the original Femtocell gateway. The one or more of the multiple Femtocells connected with the original Femtocell gateway may be selected according to the load condition of the multiple Femtocells connected with mobile terminals. For a Femtocell that performs selection and needs to change the Femtocell gateway, the factors to be considered are not limited to the load condition of the multiple Femtocells connected with the mobile terminals, and are not repeatedly described here.

Step 403: The Femtocell receives the registration request message sent by the original Femtocell gateway.

Step 404: The Femtocell sends a Femtocell gateway selection request message to the SON server.

The Femtocell includes the information about the reason for selecting a Femtocell gateway and/or the identification information of the original Femtocell gateway in the message, where the information about the reason for selecting a Femtocell gateway may be information about the reason for registration failure, information about the reason for deregistration, and so on.

After step 404, step 305 to step 310 as described in the foregoing embodiment are performed.

Through step 401 to step 404 and step 305 to step 310, the Femtocell is enabled to be connected to the target Femtocell gateway through the security gateway, and through the target Femtocell gateway, provides the mobile terminals with the service of access to the WiMAX service network.

In this embodiment, after step 309 where the Femtocell establishes the communication interface with the target Femtocell gateway and registers to the target Femtocell gateway through the communication interface, step 311a is further included, where the Femtocell returns a deregistration request response message to the original Femtocell gateway, indicating the result of the Femtocell's response to the deregistration request.

For the method according to the embodiment of the present invention, the sequence of the steps may be adjusted or the steps may be combined according to actual needs. If at the time of initialization, the Femtocell has established a communication connection with the security gateway connected with the target Femtocell, and has established a communication interface and registered with the target Femtocell, step 309 may not be performed. With the method for selecting a Femtocell gateway provided by the embodiments of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway is selected when the original Femtocell gateway connected with the Femtocell experiences such circumstances as an overload after the Femtocell works normally upon power-on initialization, thus solving the problem that the quality of communication services of user equipments is affected because the Femtocell gateway cannot provide normal services.

Further, the target Femtocell gateway and the original Femtocell gateway may not necessarily be connected with the Femtocell through the same security gateway.

A method for selecting a Femtocell gateway provided by yet another embodiment of the present invention further includes: judging, by the SON server, whether the security gateway connected with the target Femtocell gateway and the security gateway connected with the original Femtocell gateway are the same security gateway, thereby avoiding the occurrence of a circumstance under which the target Femtocell gateway and the original Femtocell gateway are not connected with the Femtocell through the same security gateway so that the target Femtocell gateway cannot communicate with the Femtocell. Specific steps of the method include the above step 401 to step 404, step 305 to step 308, step 312a to 316a, step 309 to 310, and step 317, and are not repeatedly described here.

A method for selecting a Femtocell gateway provided by yet another embodiment of the present invention also includes: judging, by the Femtocell, whether the security gateway connected with the target Femtocell gateway and the security gateway connected with the original Femtocell gateway are the same security gateway, thereby avoiding the occurrence of a circumstance under which the target Femtocell gateway and the original Femtocell gateway are not connected with the Femtocell through the same security gateway so that the target Femtocell gateway cannot communicate with the Femtocell. Specific steps of the method include the above step 401 to step 404, step 305 to step 308, step 312b to 313b, step 309 to 310, and step 317, and are not repeatedly described here.

For the method according to the embodiment of the present invention, the sequence of the steps may be adjusted or the steps may be combined according to actual needs. With the method for selecting a Femtocell gateway according to the embodiment of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway is selected when the original Femtocell gateway connected with the Femtocell cannot provide normal services after the Femtocell works normally upon power-on initialization, thus solving the problem that the quality of communication services of user equipments is affected because the Femtocell gateway cannot provide normal services.

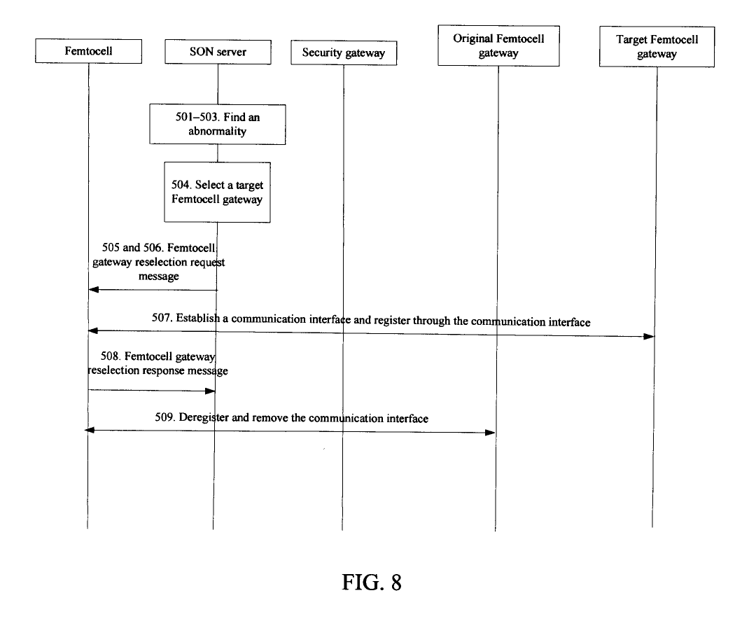

As shown in FIG. 8, a method for selecting a Femtocell gateway provided by another embodiment of the present invention is applied during the operation of the network. The implementation of this method is subject to a condition that the Femtocell connects to the Femtocell gateway through the security gateway, and through the Femtocell gateway, provides the mobile terminal with the service of access to the WiMAX service network.

In the embodiment of the present invention, the SON server judges, according to the load-related information of the original Femtocell gateway that is obtained by the SON server, the load condition of the original Femtocell gateway, further determines, according to the load condition, that the Femtocell gateway cannot provide normal services for the Femtocell, and when the Femtocell gateway cannot provide normal services for the Femtocell, allocates a suitable Femtocell gateway to the Femtocell, that is, the target Femtocell gateway. The specific steps of this embodiment are as follows:

Step 501: The SON server obtains the load-related information of the original Femtocell gateway.

Step 502: The SON server calculates the load condition of the original Femtocell gateway according to the load-related information.

In this embodiment, the SON server periodically calculates the load condition of the original Femtocell gateway by querying the load of each WiMAX Femtocell connected with the original Femtocell gateway. This query mechanism has been defined in the current SON protocol, and is not repeatedly described here.

Step 503: When the load condition of the original Femtocell gateway is overload, the SON server determines that the Femtocell gateway cannot provide normal services for the

Femtocell.

In this embodiment, in steps 501 to 503, it is implemented to judge whether the Femtocell gateway can provide normal services for the Femtocell through the SON server, and the judgment procedure may be performed periodically.

Step 504: When the original Femtocell gateway cannot provide normal services for the Femtocell, the SON server selects a target Femtocell gateway that can replace the original Femtocell gateway; and a specific implementation of this step is the same as step 306, and is not repeatedly described here.

Step 505: The SON server sends a message that carries identification information of the target Femtocell gateway, that is, a Femtocell gateway selection message, to the Femtocell. The identification information of the target Femtocell gateway here may be an IP address or a MAC address of the target Femtocell gateway, or other information that may identify the identity or the communication address of the Femtocell gateway in the network.

Step 506: The Femtocell receives the message that carries the identification information of the target Femtocell gateway, that is, the Femtocell gateway selection message.

Step 507: The Femtocell establishes, according to the identification information of the target Femtocell gateway in the message, a communication interface with the target Femtocell gateway, and registers to the target Femtocell gateway through the communication interface.

Step 508: The Femtocell returns a Femtocell gateway selection response message to the SON server. The moment at which this message is sent is not limited, and this message may also be sent before or after step 507 or step 509, according to the specific implementation.

Step 509: The Femtocell deregisters with the original Femtocell gateway to cancel the registration of the Femtocell in the original Femtocell gateway, and removes the communication interface with the original Femtocell gateway.

For the method according to the embodiment of the present invention, the sequence of the steps may be adjusted or the steps may be combined according to actual needs. With the method for selecting a Femtocell gateway according to the embodiment of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway is selected when the original Femtocell gateway connected with the Femtocell cannot provide normal services after the Femtocell works normally upon power-on initialization, thus solving the problem that the quality of communication services of user equipments is affected because the Femtocell gateway cannot provide normal services.

Further, the target Femtocell gateway and the original Femtocell gateway may not necessarily be connected with the Femtocell through the same security gateway.

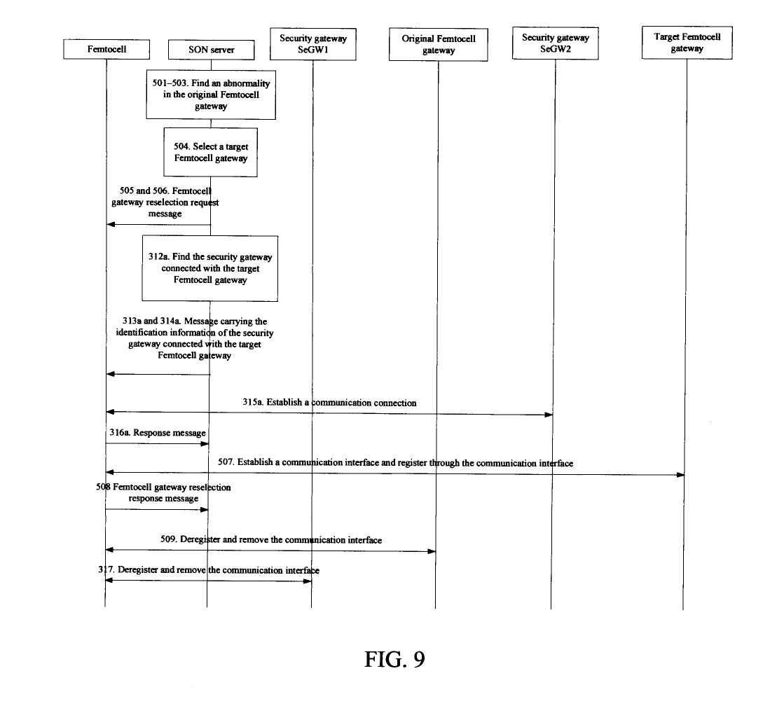

In a method for selecting a Femtocell gateway provided by another embodiment of the present invention, as shown in FIG. 9, the SON server judges whether the security gateway connected with the target Femtocell gateway and the security gateway connected with the original Femtocell gateway are the same security gateway, avoiding the occurrence of a circumstance under which the target Femtocell gateway and the original Femtocell gateway are not connected with the Femtocell through the same security gateway so that the target Femtocell gateway cannot communicate with the Femtocell. Specific steps of the method include the above step 501 to step 506, step 312a to step 316a, step 507 to step 509, and step 317, and are not repeatedly described here.

For the method according to the embodiment of the present invention, the sequence of the steps may be adjusted or the steps may be combined according to actual needs. Step 312a may be combined with step 504, that is, selecting the target Femtocell gateway at the same time when finding the security gateway connected with the target Femtocell gateway. In this case, the identification information of the security gateway connected with the target Femtocell gateway may be carried in the Femtocell gateway selection request message of step 505 and step 506 and sent to the Femtocell, and steps 313a and 314a may not be performed. If at the time of initialization, the Femtocell has established a communication connection with the security gateway connected with the target Femtocell, and has established a communication interface and registered with the target Femtocell, steps 315a and 507 may not be performed.

With the method for selecting a Femtocell gateway provided by the embodiment of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway is selected when the original Femtocell gateway connected with the Femtocell cannot provide normal services after the Femtocell works normally upon power-on initialization, thus solving the problem that the quality of communication services of user equipments is affected because the Femtocell gateway cannot provide normal services.

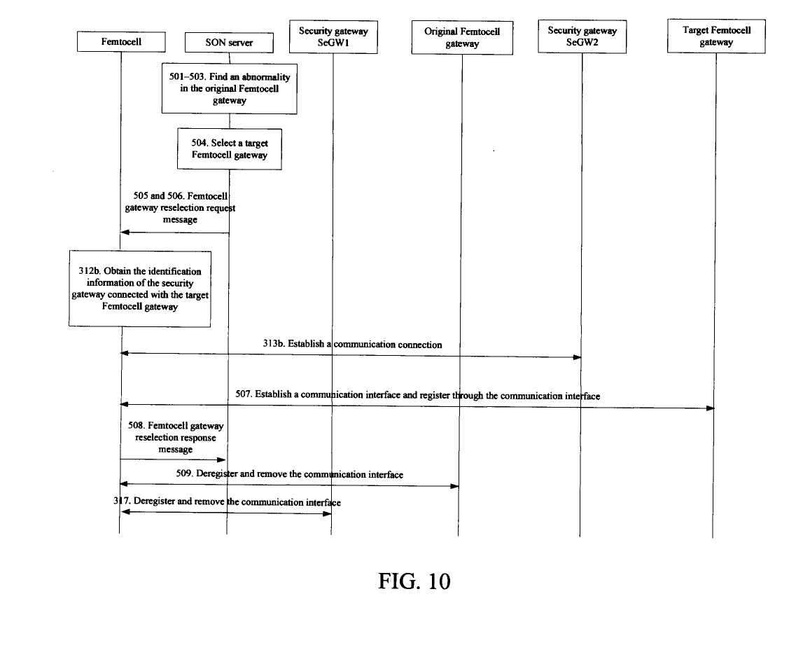

In a method for selecting a Femtocell gateway provided by another embodiment of the present invention, as shown in FIG. 10, the Femtocell judges whether the security gateway connected with the target Femtocell gateway and the security gateway connected with the original Femtocell gateway are the same security gateway, avoiding the occurrence of a circumstance under which the target Femtocell gateway and the original Femtocell gateway are not connected with the Femtocell through the same security gateway so that the target Femtocell gateway cannot communicate with the Femtocell. The specific steps of the method include the above step 501 to step 506, and also the above step 312b to 313b, step 507 to 509, and step 317, and are not repeatedly described here.

For the method according to the embodiment of the present invention, the sequence of the steps may be adjusted or the steps may be combined according to actual needs. With the method for selecting a Femtocell gateway according to the embodiment of the present invention, the SON server sends a message that carries the identification information of the target Femtocell gateway to the Femtocell connected with the original Femtocell gateway, so that the Femtocell abandons the original Femtocell gateway and connects to the target Femtocell gateway, and therefore, an accessible target Femtocell gateway is selected when the original Femtocell gateway connected with the Femtocell cannot provide normal services after the Femtocell works normally upon power-on initialization, thus solving the problem that the quality of communication services of user equipments is affected because the Femtocell gateway cannot provide normal services.

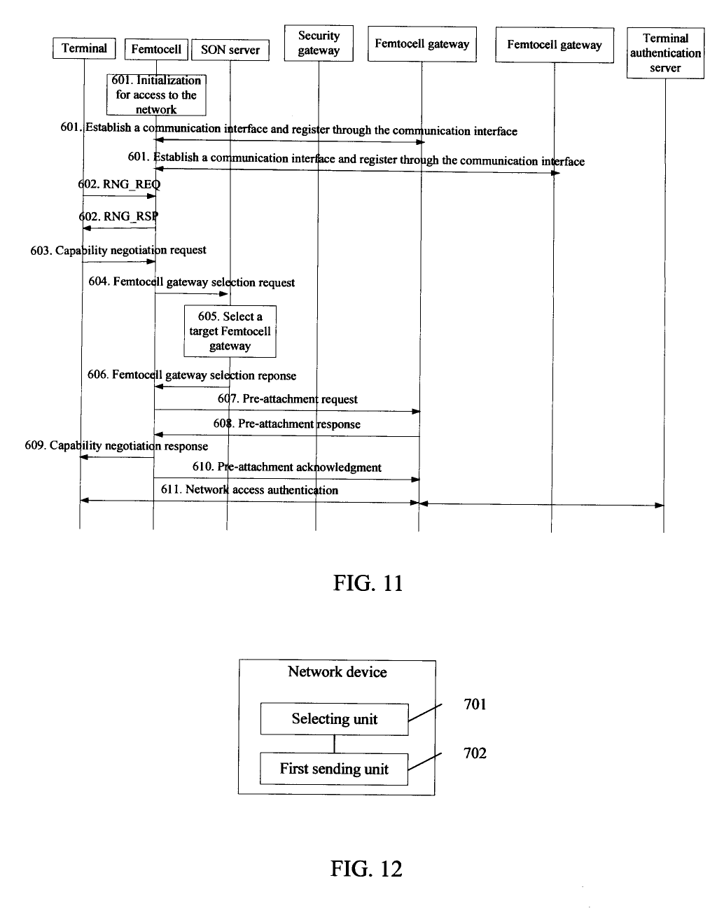

In order to implement load balancing among Femtocell gateways, in addition to using the technical solution provided by the foregoing embodiment where the Femtocell selects, according to the service capability information of the Femtocell gateway, the Femtocell gateway used by the Femtocell when accessing the network, it is also possible to use the method of selecting, by the Femtocell according to the service capability of the Femtocell gateway, a suitable Femtocell gateway for the terminal when the terminal accesses the network, so that the allocation optimization of the terminal on different Femtocell gateways is implemented, and therefore, load balancing is implemented among the Femtocell gateways. As shown FIG. 11, a method for selecting a Femtocell gateway provided by still another embodiment of the present invention includes the following:

Step 601: The Femtocell obtains, during initialization, multiple available Femtocell gateways designated by the SON server, and the Femtocell establishes an R6-F communication interface with one or more of these Femtocell gateways and performs registration.

Step 602: When the terminal needs to access the Femtocell network, the terminal sends an RNG_REQ (ranging request) message that includes network access request indication information, and the Femtocell receives the network access request message sent by the terminal and sends an RNG_RSP (ranging response) message to the terminal.

Step 603: After receiving the ranging response message, the terminal sends a capability negotiation request message to the Femtocell.

Step 604: After receiving the capability negotiation request message sent by the terminal to the Femtocell, the Femtocell sends, with respect to the terminal requesting for access to the network, a Femtocell gateway selection request message to the SON server in the network to request allocation of a Femtocell gateway. This message may carry information about Femtocell gateway, where the information about Femtocell gateway is available to the Femtocell and is for reference when the SON selects a Femtocell gateway. This message may also include information about the reason for selecting a Femtocell gateway, and the information about the reason for selecting a Femtocell gateway mentioned in this embodiment may be one or more types of information, such as initial network access of the terminal, network access of the terminal during a handover to a target base station, failure in a pre-attachment of the terminal to the original Femtocell gateway.

Optionally, after receiving the capability negotiation request message sent by the terminal to the Femtocell, the Femtocell may also directly select an available Femtocell gateway (default or random) to initiate a pre-attachment request, and after receiving a pre-attachment failure message sent by the Femtocell gateway, send a Femtocell gateway selection request message to the SON server in the network to request for allocation of a Femtocell gateway, and carry, in the message, the information about the Femtocell gateway and/or the identification information of the Femtocell gateway which fails in the pre-attachment, where the information about the Femtocell gateway and/or the identification information of the Femtocell gateway which fails in the pre-attachment are available to the Femtocell and are for reference when the SON server makes the selection. The specific implementation is the same as the steps of the foregoing embodiment after the Femtocell receives the deregistration request message or the registration failure response message sent by the original Femtocell gateway, and is not repeatedly described here.

Step 605: The SON server selects, according to the service capability information of each Femtocell gateway, where the service capability information of each Femtocell gateway is currently available to the Femtocell, one target Femtocell gateway for the terminal which accesses the network from the Femtocell.

Step 606: The SON server sends the identification information of the Femtocell gateway (such as the IP address or MAC address of the Femtocell gateway) to the Femtocell through the Femtocell gateway selection response message.

Step 607: With respect to the terminal requesting for access to the network, the Femtocell sends a pre-attachment request message (such as a Pre-attachment request) to the Femtocell gateway (namely, the target Femtocell gateway) designated by the SON server in the Femtocell gateway selection response message. If the Femtocell does not establish the R6-F communication interface with the designated Femtocell gateway during the initialization and perform the registration, the R6-F communication interface with the designated Femtocell gateway may be established and the registration may be performed in advance before the pre-attachment request message (Pre-attachment request) is sent to the designated Femtocell gateway.

Step 608: The Femtocell gateway sends a pre-attachment response message (such as a Pre-attachment response) to the Femtocell.

Step 609: The Femtocell sends a capability negotiation response message to the terminal.

Step 610: The Femtocell sends a pre-attachment acknowledgment message to the corresponding Femtocell gateway.

Step 611: The terminal performs a network access authentication procedure in a terminal authentication server through the corresponding Femtocell gateway.

After the terminal successfully pre-attaches to the target Femtocell gateway, the terminal further performs a network access authentication procedure in the terminal authentication server (such as H-AAA) through the target Femtocell gateway. For this authentication procedure, reference may be made the definition of the terminal authentication procedure in existing specifications.

With the method for selecting a Femtocell gateway provided by the embodiment of the present invention, the SON server selects the target Femtocell gateway used by the terminal for access to the network, and the SON server sends a message that carries the identification information of the target Femtocell gateway to the Femtocell used by the terminal for access to the network. Thereby, the Femtocell can select the target Femtocell gateway that can provide normal services (for example, can provide the quality of service required by the service of the terminal); the success of the pre-attachment operation performed by the target Femtocell gateway for the terminal requesting for access to the network is ensured to the maximum extent; and the problem that the quality of communication services of user equipments and user experiences are affected because the Femtocell gateway cannot provide normal services is solved. The SON server as described in this embodiment is a logical network management functional entity which may be deployed separately or deployed on the Femtocell gateway. If the SON server is deployed on the Femtocell gateway, the Femtocell gateway selection request/response message sent between the Femtocell and the Femtocell gateway is just sent and received between the Femtocell gateway and the Femtocell. In this case, the messages already defined in the standard specifications may be reused for the Femtocell gateway selection request/response message, such as the registration request/response message used for registration of the Femtocell with the Femtocell gateway (Register request) and the pre-attachment request/response message used in performing a pre-attachment for the terminal (Pre-attachment request).

As shown in FIG. 12, a network management entity provided by an embodiment of the present invention, such as a SON server, includes the following.

The selecting unit 701 is configured to select, according to service capability information of Femtocell gateway in the current network, a target Femtocell gateway. For the specific implementation thereof, reference may be made to step 101 as shown in FIG. 1, and is not repeatedly described here.

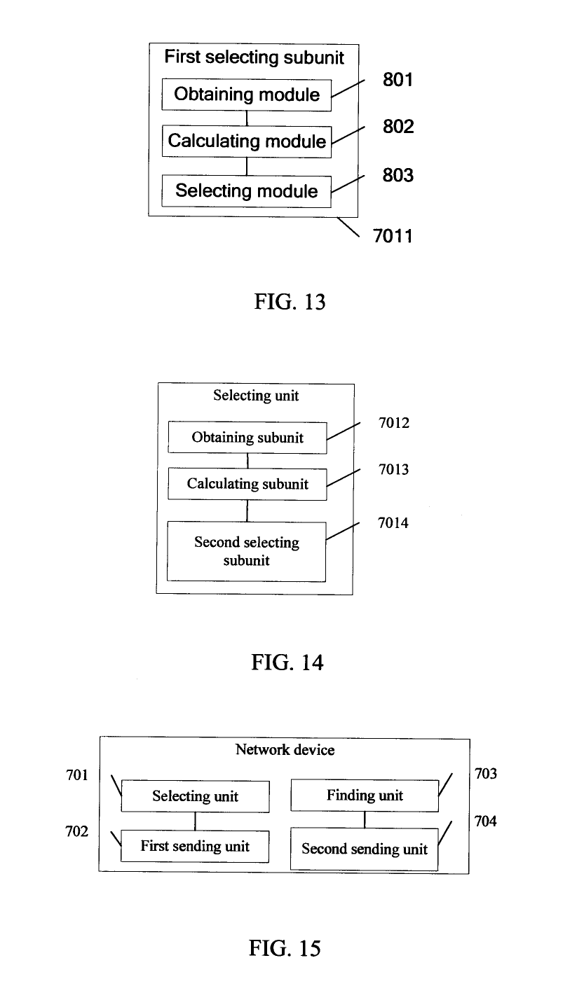

The selecting unit, as shown in FIG. 13, includes:

a first selecting subunit 7011, configured to select, when receiving a Femtocell gateway selection request message sent by the Femtocell, the target Femtocell gateway according to the service capability information of the Femtocell gateway in the current network. For the specific implementation thereof, reference may be made to step 305 as shown in FIG. 4, and is not repeatedly described here.

In this embodiment, the first selecting subunit includes: an obtaining module 801, configured to obtain load information of the Femtocell connected with the Femtocell gateway in the current network; a calculating module 802, configured to calculate the load condition of the Femtocell gateway in the current network according to the load information of the Femtocell connected with the Femtocell gateway in the current network that is obtained by the obtaining unit; and a selecting module 803, configured to select the target Femtocell gateway according to the load condition of the Femtocell gateway in the current network that are calculated by the calculating module.

Alternatively, the selecting unit, as shown in FIG. 14, includes:

an obtaining subunit 7012, configured to obtain the load information of the Femtocell connected with the original Femtocell gateway; for the specific implementation thereof, reference may be made to step 501 as shown in FIG. 8, and is not repeatedly described here;

a calculating subunit 7013, configured to calculate the load condition of the original Femtocell gateway according to the load information of the Femtocell connected with the original Femtocell gateway that is obtained by the obtaining subunit; for the specific implementation thereof, reference may be made to step 502 as shown in FIG. 8, and is not repeatedly described here; and

a second selecting subunit 7014, configured to select, when the load condition of the original Femtocell gateway that is calculated by the calculating subunit is overload, the target Femtocell gateway according to the service capability information of the Femtocell gateway in the current network; for the specific implementation thereof, reference may be made to step 503 as shown in FIG. 8, and is not repeatedly described here.

The first sending unit 702 is configured to send a message that carries identification information of the target Femtocell gateway selected by the selecting unit to the Femtocell. For the specific implementation thereof, reference may be made to step 102 as shown in FIG. 1, and is not repeatedly described here.

In order to determine that the original Femtocell gateway accessed by the Femtocell cannot provide normal services for the Femtocell, an embodiment of the present invention provides a network device.

Further, in order to prevent the occurrence of a circumstance under which the target Femtocell gateway and the original Femtocell gateway are not connected the WiMAX Femtocell through the same security gateway, the network device provided by an embodiment of the present invention, on the basis of the foregoing embodiments, as shown in FIG. 15, further includes:

a finding unit 703, configured to find, when the security gateway connected with the target Femtocell gateway and the security gateway connected with the original Femtocell gateway are not the same security gateway, the security gateway connected with the target Femtocell gateway; for the specific implementation thereof, reference may be made to step 312a as shown in FIG. 5, and is not repeatedly described here; and

a second sending unit 704, configured to send a message that carries the identification information of the security gateway connected with the target Femtocell gateway and found by the finding unit to the Femtocell; for the specific implementation thereof, reference may be made to step 313a as shown in FIG. 5, and is not repeatedly described here.

With the network device provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

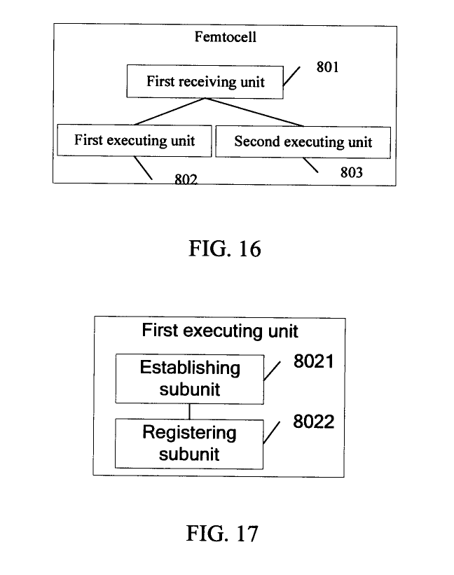

As shown in FIG. 16, a Femtocell provided by an embodiment of the present invention includes:

a first receiving unit 801, configured to obtain a message that carries identification information of a target Femtocell gateway; for the specific implementation thereof, reference may be made to step 201 as shown in FIG. 2, and is not repeatedly described here;

a first executing unit 802, configured to establish, according to the identification information of the target Femtocell gateway in the message obtained by the first receiving unit, a communication connection with the target Femtocell gateway; for the specific implementation thereof, reference may be made to step 202 as shown in FIG. 2, and is not repeatedly described here; and/or

a second executing unit 803, configured to perform, according to the identification information of the target Femtocell gateway in the message received by the first receiving unit, a pre-attachment operation for a terminal requesting for access to the network; for the specific implementation thereof, reference may be made to step 203 as shown in FIG. 2, and is not repeatedly described here.

In this embodiment, the first executing unit, as shown in FIG. 17, includes:

an establishing subunit 8021, configured to establish, according to the identification information of the target Femtocell gateway in the message obtained by the first receiving unit, a communication interface with the target Femtocell gateway; and

a registering subunit 8022, configured to register with the target Femtocell gateway through the communication interface established by the establishing subunit.

With the Femtocell provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

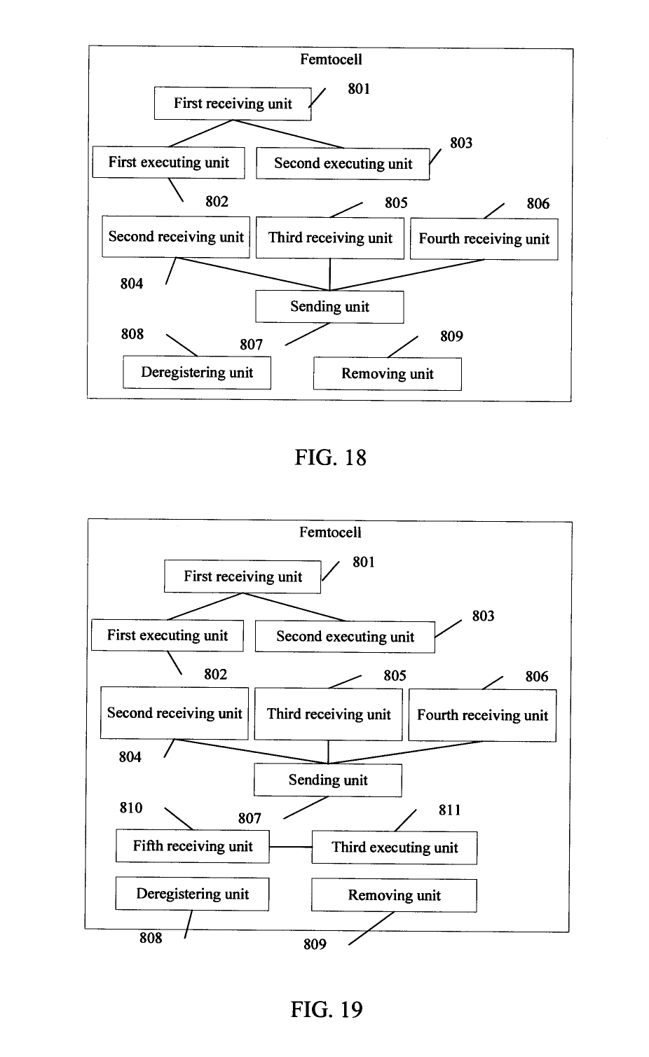

A Femtocell provided by another embodiment of the present invention implements, on the basis of the foregoing embodiment, the function of actively requesting for selecting a Femtocell gateway. As shown in FIG. 18, on the basis of the foregoing embodiment, the Femtocell further includes:

a second receiving unit 804, configured to receive a registration failure response message sent by the original Femtocell gateway, where the registration failure response message includes information about the reason for registration failure; for the specific implementation thereof, reference may be made to step 303 as shown in FIG. 4, and is not repeated described here;

a third receiving unit 805, configured to receive a deregistration request message or a terminal pre-attachment failure message sent by the original Femtocell gateway, where the deregistration request message includes overload information or registration failure information; for the specific implementation thereof, reference may be made to step 403 as shown in FIG. 7 and step 604 as shown in FIG. 11, and is not repeatedly described here;

a fourth receiving unit 806, configured to receive from a terminal a message for requesting for access to the network; for the specific implementation thereof, reference may be made to step 602 and step 603 as shown in FIG. 11, and is not repeatedly described here;

a sending unit 807, configured to send a Femtocell gateway selection request message to a network management entity; for the specific implementation thereof, reference may be made to step 304 as shown in FIG. 4, and is not repeatedly described here;

a deregistering unit 808, configured to deregister with the original Femtocell gateway; for the specific implementation thereof, reference may be made to step 509 as shown in FIG. 8, and is not repeated described here; and

a removing unit 809, configured to remove the communication interface with the original Femtocell gateway; for the specific implementation thereof, reference may be made to step 310 as shown in FIG. 4 and step 509 as shown in FIG. 8, and is not repeatedly described here.

With the Femtocell provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

A Femtocell provided by yet another embodiment of the present invention, on the basis that the SON server discovers that the security gateway connected with the target Femtocell gateway and the security gateway connected with the original Femtocell are not the same security gateway, as shown in FIG. 19, on the basis of the two foregoing embodiments, further includes:

a fifth receiving unit 810, configured to receive a message that carries the identification information of the security gateway connected with the target Femtocell gateway; for the specific implementation thereof, reference may be made to step 314a as shown in FIG. 5, and is not repeatedly described here; and

a third executing unit 811, configured to establish a communication connection with the security gateway according to the message that is received by the receiving unit and carries the identification information of the security gateway connected with the target Femtocell gateway; for the specific implementation thereof, reference may be made to step 315a as shown in FIG. 5, and is not repeatedly described here.

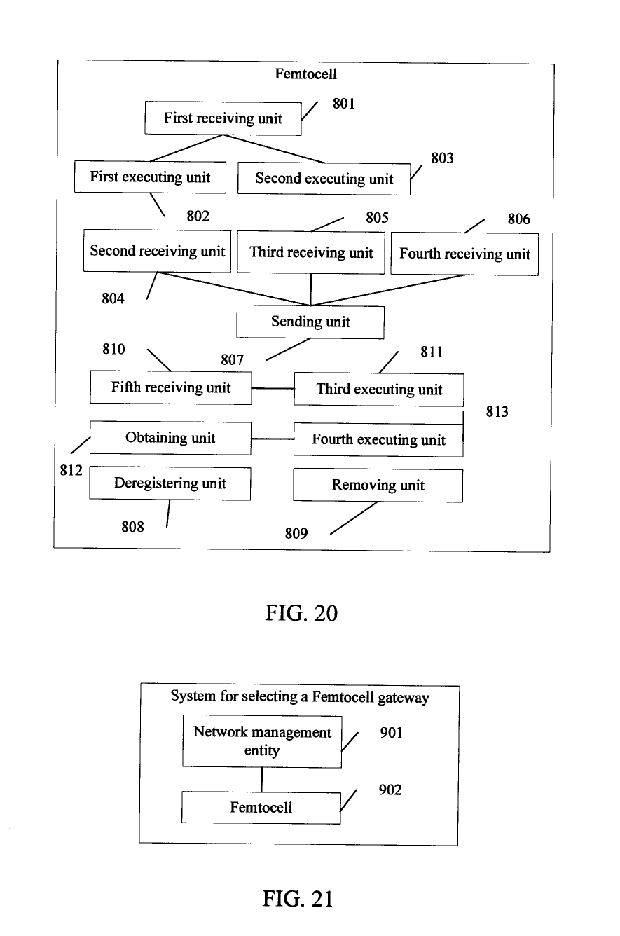

With a Femtocell provided by yet another embodiment of the present invention, the Femtocell implements the function of discovering that the security gateway connected with the target Femtocell gateway and the security gateway connected with the original Femtocell are not the same security gateway. Then, as shown in FIG. 20, on the basis of the embodiment of the present invention and still another embodiment of the present invention, the Femtocell further includes:

an obtaining unit 812, configured to obtain, when the security gateway connected with the target Femtocell gateway and the security gateway connected with the original Femtocell gateway are not the same security gateway, the identification information of the security gateway connected with the target Femtocell gateway; for the specific implementation thereof, reference may be made to step 312b as shown in FIG. 6, and is not repeated described here; and

a fourth executing unit 813, configured to establish a communication connection with the security gateway according to the identification information of the security gateway that is obtained by the obtaining unit; for the specific implementation thereof, reference may be made to step 313b as shown in FIG. 6, and is not repeatedly described here.

With the Femtocell provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

A system for selecting a Femtocell gateway provided by an embodiment of the present invention, as shown in FIG. 21, includes:

a network management entity 901, as shown in FIG. 13 to FIG. 15, configured to select a target Femtocell gateway according to service capability information of Femtocell gateway in the current network, and send a message that carries identification information of the target Femtocell gateway to the Femtocell; the specific structure and function are basically similar to the structure and function of the foregoing network device embodiment, and are not repeatedly described here; and

a Femtocell 902, as shown in FIG. 16 to FIG. 20, configured to receive the message that carries identification information of the target Femtocell gateway, and establish, according to the identification information of the target Femtocell gateway in the message, a communication connection with the target Femtocell gateway, and/or perform, through the target Femtocell gateway according to the identification information of the target Femtocell gateway in the message, a pre-attachment operation for a terminal requesting for access to the network; the specific structure and function are basically similar to the structure and function of the foregoing network device embodiment, and are not repeatedly described here.

In the system for selecting a Femtocell gateway provided by the embodiment of the present invention, the network management entity sends a message that carries the identification information of the target Femtocell gateway to the Femtocell connected with the original Femtocell gateway, so that the Femtocell selects the target Femtocell gateway that can provide normal services, and therefore the problem that the quality of communication services of user equipments is affected because the Femtocell gateway cannot provide normal services is solved.

The method, device, and system for selecting a Femtocell gateway provided by the embodiments of the present invention can be applied in radio networks such as the worldwide interoperability for microwave access (WiMAX) network.

Persons of ordinary skill in the art may understand that all or part of steps in the methods of the above embodiments may be implemented by relevant hardware instructed by a program. The program may be stored in a computer readable storage medium, such as a ROM, a RAM, a magnetic disk, and an optical disk.

Detailed above are only specific embodiments of the present invention, but the protection scope of the present invention is not limited thereto. Any modification or substitution readily conceivable by those skilled in the art within the scope of the technology disclosed in the present invention shall be covered within the protection scope of the present invention. Therefore, the protection scope of the present invention is subject to the appended claims.

What is claimed is:

1. A method for selecting a Femtocell gateway, comprising:
selecting a target Femtocell gateway according to service capability information of a Femtocell gateway in a current network; and
sending a message that carries identification information of the target Femtocell gateway to a Femtocell for the Femtocell to access, according to the identification information of the target Femtocell gateway, the target Femtocell gateway corresponding to the identification information of the target Femtocell gateway, or for the Femtocell to perform, through the target Femtocell gateway, a pre-attachment operation for a terminal requesting for access to the network.

2. The method according to claim 1, wherein the service capability information of the Femtocell gateway in the current network is load capability information of the Femtocell gateway in the current network.

3. The method according to claim 1, wherein the selecting the target Femtocell gateway according to the service capability information of the Femtocell gateway in the current network comprises:
selecting, when receiving a Femtocell gateway selection request message sent by the Femtocell, the target Femtocell gateway according to the service capability information of the Femtocell gateway in the current network.

4. The method according to claim 2, wherein the selecting the target Femtocell gateway according to the service capability information of the Femtocell gateway in the current network comprises:
selecting, when receiving a Femtocell gateway selection request message sent by the Femtocell, the target Femtocell gateway according to the service capability information of the Femtocell gateway in the current network.

5. The method according to claim 3, wherein the selecting, when receiving the Femtocell gateway selection request message sent by the Femtocell, the target Femtocell gateway according to the service capability information of the Femtocell gateway in the current network comprises:
obtaining load information of a Femtocell connected with the Femtocell gateway in the current network;
calculating, according to the load information of the Femtocell connected with the Femtocell gateway in the current network, a load condition of the Femtocell gateway in the current network; and
selecting the target Femtocell gateway according to the load condition of the Femtocell gateway in the current network.

6. The method according to claim 1, wherein the selecting the target Femtocell gateway according to the service capability information of the Femtocell gateway in the current network comprises:
obtaining load information of a Femtocell connected with an original Femtocell gateway;
calculating, according to the load information of the Femtocell connected with the original Femtocell gateway, a load condition of the original Femtocell gateway; and
when the load condition of the original Femtocell gateway is overload, selecting the target Femtocell gateway according to the service capability information of the Femtocell gateway in the current network.

7. The method according to claim 1, further comprising:
when a security gateway connected with the target Femtocell gateway and a security gateway connected with the original Femtocell gateway are not the same security gateway,
sending a message that carries identification information of the security gateway connected with the target Femtocell gateway to the Femtocell.

8. The method according to claim 3, further comprising:
when a security gateway connected with the target Femtocell gateway and a security gateway connected with the original Femtocell gateway are not the same security gateway,
sending a message that carries identification information of the security gateway connected with the target Femtocell gateway to the Femtocell.

9. A method for selecting a Femtocell gateway, comprising:
receiving a message that carries identify information of a target Femtocell gateway; and
establishing, according to the identification information of the target Femtocell gateway in the message, a communication connection with the target Femtocell gateway, or
performing, according to the identification information of the target Femtocell gateway in the message, a pre-attachment operation for a terminal requesting for access to a network.

10. The method according to claim 9, before the receiving the message that carries the identify information of the target Femtocell gateway, further comprising: sending a Femtocell gateway selection request message to a network management entity for the network management entity to select the target Femtocell gateway;
before the sending the Femtocell gateway selection request message to the network management entity, the method further comprising:
receiving a registration failure response message sent by an original Femtocell gateway, wherein the registration failure response message comprises information about a reason for registration failure, or
receiving a deregistration request message or a pre-attachment failure message sent by the original Femtocell gateway, wherein the deregistration request message comprises information about a reason for deregistration, or
receiving a network access request message sent by the terminal.

11. The method according to claim 10, wherein the Femtocell gateway selection request message sent to the network management entity comprises information about a reason for selecting a Femtocell gateway.

12. The method according to claim 9, wherein the establishing the communication connection with the target Femtocell gateway comprises:
establishing, according to the identification information of the target Femtocell gateway in the message, a communication interface with the target Femtocell gateway; and
registering with the target Femtocell gateway through the communication interface.

13. The method according to claim 12, further comprising:
deregistering with an original Femtocell gateway; and
removing a communication interface with the original Femtocell gateway.

14. The method according to claim 9, before the establishing, according to the identification information of the target Femtocell gateway in the message, the communication connection with the target Femtocell gateway, further comprising:
receiving a message that carries identification information of a security gateway connected with the target Femtocell gateway; and
establishing a communication connection with the security gateway according to the identification information of the security gateway connected with the target Femtocell gateway.

15. The method according to claim 9, further comprising:
when a security gateway connected with the target Femtocell gateway and a security gateway connected with the original Femtocell gateway are not the same security gateway, obtaining identification information of the security gateway connected with the target Femtocell gateway; and
establishing a communication connection with the security gateway according to the identification information of the security gateway.

16. The method according to claim 9, after the performing, according to the identification information of the target Femtocell gateway in the message, the pre-attachment operation for the terminal requesting for access to the network, further comprising:
performing a network access authentication procedure for the terminal requesting for access to the network.

17. A network management device, comprising:
a selecting unit, configured to select a target Femtocell gateway according to service capability information of a Femtocell gateway in a current network; and
a first sending unit, configured to send a message that carries identification information of the target Femtocell gateway selected by the selecting unit to the Femtocell.

18. The network management device according to claim 17, wherein the selecting unit comprises:
a first selecting subunit, configured to select, when receiving a Femtocell gateway selection request message sent by the Femtocell, the target Femtocell gateway according to the service capability information of the Femtocell gateway in the current network.

19. The network management device according to claim 18, wherein the first selecting subunit comprises:
an obtaining module, configured to obtain load information of a Femtocell connected with the Femtocell gateway in the current network;
a calculating module, configured to calculate, according to the load information of the Femtocell connected with the Femtocell gateway in the current network that is obtained by the obtaining unit, a load condition of the Femtocell gateway in the current network; and
a selecting module, configured to select the target Femtocell gateway according to the load condition of the Femtocell gateway in the current network that is calculated by the calculating module.

20. The network management device according to claim 17, wherein the selecting unit comprises:
an obtaining subunit, configured to obtain load information of a Femtocell connected with an original Femtocell gateway;
a calculating subunit, configured to calculate, according to the load information of the Femtocell connected with the original Femtocell gateway that is obtained by the obtaining subunit, a load condition of the original Femtocell gateway; and
a second selecting subunit, configured to select, when the load condition of the original Femtocell gateway that is calculated by the calculating subunit is overload, the target Femtocell gateway according to the service capability information of the Femtocell gateway in the current network.

21. The network management device according to claim 17, further comprising:
a finding unit, configured to find, when a security gateway connected with the target Femtocell gateway and a security gateway connected with the original Femtocell are not the same security gateway, the security gateway connected with the target Femtocell gateway; and
a second sending unit, configured to send a message that carries identification information of the security gateway connected with the target Femtocell gateway and found by the finding unit to the Femtocell.

22. A Femtocell, comprising:
a first receiving unit, configured to receive a message that carries identification information of a target Femtocell gateway; and
a first executing unit, configured to establish, according to the identification information of the target Femtocell gateway in the message received by the first receiving unit, a communication connection with the target Femtocell gateway, or
a second executing unit, configured to perform, according to the identification information of the target Femtocell gateway in the message received by the first receiving unit, a pre-attachment operation for a terminal requesting for access to a network.

23. The Femtocell according to claim 22, further comprising:
a second receiving unit, configured to receive a registration failure response message sent by an original Femtocell gateway, wherein the registration failure response message comprises information about a reason for registration failure; or
a third receiving unit, configured to receive a deregistration request message or a terminal pre-attachment failure message sent by the original Femtocell gateway, wherein the deregistration request message comprises information about a reason for deregistration; or
a fourth receiving unit, configured to receive a network access request message sent by the terminal; and
a sending unit, configured to send a Femtocell gateway selection request message to a network management entity.

24. The Femtocell according to claim 22, wherein the first executing unit comprises:
an establishing subunit, configured to establish, according to the identification information of the target Femtocell gateway in the message obtained by the first receiving unit, a communication interface with the target Femtocell gateway; and
a registering subunit, configured to register with the target Femtocell gateway through the communication interface established by the establishing subunit.

25. The Femtocell according to claim 24, further comprising:
a deregistering unit, configured to deregister with an original Femtocell gateway; and
a removing unit, configured to remove a communication interface with the original Femtocell gateway.

26. The Femtocell according to claim 22, further comprising:
a fifth receiving unit, configured to receive a message that carries identification information of a security gateway connected with the target Femtocell gateway; and
a third executing unit, configured to establish a communication connection with the security gateway according to the identification information of the security gateway connected with the target Femtocell gateway in the message received by the receiving unit.

27. The Femtocell according to claim 22, further comprising:
an obtaining unit, configured to obtain, when a security gateway connected with the target Femtocell gateway and a security gateway connected with the original Femtocell gateway are not the same security gateway, identification information of the security gateway connected with the target Femtocell gateway; and
a fourth executing unit, configured to establish a communication connection with the security gateway according to the identification information of the security gateway that is obtained by the obtaining unit.

28. A system for selecting a Femtocell gateway, comprising:
a network management entity, configured to select a target Femtocell gateway according to service capability information of a Femtocell gateway in a current network, and send a message that carries identification information of the target Femtocell gateway to the Femtocell; and
a Femtocell, configured to receive the message that carries the identification information of the target Femtocell gateway, and establish, according to the identification information of the target Femtocell gateway in the message, a communication connection with the target Femtocell gateway, or perform, through the target Femtocell gateway according to the identification information of the target Femtocell gateway in the message, a pre-attachment operation for a terminal requesting for access to the network.
